(19) United States
(12) Patent Application Publication
(10) Pub. No.: US 2016/0150284 A1
(43) Pub. Date: May 26, 2016

(54) DYNAMIC CHANNEL SELECTION FOR LIVE AND PREVIOUSLY BROADCAST CONTENT

(71) Applicant: Squaredon Co LTD, Larnaca (CY)

(72) Inventors: Igor Sokolov, Saint-Petersburg (RU); Leonid Belyaev, Moscow (RU); Ilya Baronshin, Moscow (RU); Artem Kirakosyan, St. Petersburg (RU)

(21) Appl. No.: 14/548,897

(22) Filed: Nov. 20, 2014

(51) Int. Cl. H04N 21/482; H04N 21/433; H04N 21/462

(52) U.S. Cl. CPC H04N 21/482; H04N 21/4622; H04N 21/433

(57) ABSTRACT

A video content display device can have the functionality to dynamically switch between live broadcast content and previously broadcast content. Metadata and tags can be used to identify and select broadcast content. An end-user can determine and set preferences for video content display and the end-user's preferences can be accessed via log in credentials specific to the user.

### TECHNICAL FIELD

This disclosure relates generally to live broadcast and previously broadcast features of channel broadcasts, for example, an ability to seamlessly switch between live channel broadcasts and previously recorded channel broadcasts.

### BACKGROUND

Traditional television (TV) broadcasts are scheduled by channel editors so that they may only be watched during the scheduled time for a particular channel. Personal video recorders (PVR) or digital video recorders (DVR) are consumer electronic devices that record video in a digital format to a disk drive, USB flash drive, SD memory card, or other local or networked mass storage device. Although PVR/DVR solutions allow a user to select video content to be recorded, the recording still takes place during the scheduled broadcast time for the particular video content. In contrast, Video on-demand (VOD) are systems which allow users to select and watch/listen to video or audio content when they choose to, rather than having to watch at a specific broadcast time. Internet protocol television (IPTV) technology is often used to bring video on demand to televisions and personal computers. Although VOD services allow a user to pull from a library of video content and watch video content that has previously been broadcast, there is no correlation between the previously broadcast video content and a live broadcast of video content on a same channel.

The above-described background relating to live broadcast content and previously broadcast content, is merely intended to provide a contextual overview of some current issues, and is not intended to be exhaustive. Other contextual information may become further apparent upon review of the following detailed description.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an exemplary rendering of multiple broadcast content at time t1 and time t2 where live broadcast content is selected as the primary display at time t2.

FIG. 2 illustrates an exemplary rendering of multiple broadcast content at time t1 and time t2 where previously broadcast content is selected as the primary display at time t2.

FIG. 3 illustrates an exemplary rendering of broadcast content on a separate secondary display at time t1, where previously broadcast content is selected at time t2, and where the primary display renders the previously broadcast content at time t3.

FIG. 4 illustrates a schematic process flow diagram of a method for terminating previously broadcast content and rendering live broadcast content.

FIG. 5 illustrates a schematic process flow diagram of a method for terminating previously broadcast content, rendering live broadcast content, and deleting the previously broadcast content.

FIG. 6 illustrates a schematic process flow diagram of a device switching from currently broadcast content to previously broadcast content and initiating a rendering of the previously broadcast content.

FIG. 7 illustrates a schematic process flow diagram of a device switching from currently broadcast content to previously broadcast content, initiating a rendering of the previously broadcast content, and generating metadata.

FIG. 8 illustrates a schematic process flow diagram of a device switching from currently broadcast content to previously broadcast content, initiating a rendering of the previously broadcast content, generating metadata, and using the metadata to prioritize broadcast content.

FIG. 9 illustrates a schematic process flow diagram of a computer readable storage medium for rendering a previously broadcast content item, rendering a live broadcast content item, selecting the previous broadcast content item, and terminating the live broadcast content item.

FIG. 10 illustrates a schematic process flow diagram of a computer readable storage medium for rendering a previously broadcast content item, rendering a live broadcast content item, selecting the previous broadcast content item, terminating the live broadcast item, and receiving user identification data.

FIG. 11 illustrates a block diagram of an example mobile handset operable to engage in a system architecture that facilitates secure wireless communication according to the embodiments described herein.

FIG. 12 illustrates a block diagram of an example computer operable to engage in a system architecture that facilitates secure wireless communication according to the embodiments described herein.

FIG. 13 illustrates a block diagram of an example cable television arrangement with a set-top box.

### DETAILED DESCRIPTION

In the following description, numerous specific details are set forth to provide a thorough understanding of various embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

As an overview of the various embodiments presented herein, to correct for the above identified deficiencies and other drawbacks of selection of live broadcast and previously content, various embodiments are described herein to facilitate the use of a dynamic channel broadcast selection for television and IP networks.

Smart channels can operate on TV or computer systems, including tablets and mobile phones where video can be rendered through an internal or external screen. Video content can be delivered by any available transport, including but not limited to, digital video broadcasting (DVB), satellite (SAT) TV, IP, over the top (OTT) content, and/or information data feed. A smart TV channel can allow a user to watch live broadcast content or on-demand broadcast content, which was previously broadcast, within the same broadcast channel. The previous broadcast content can be split into pieces of content, enriched by metadata and presented as on-demand video content, where a user can choose to watch any piece of content available on the channel. Combining previously broadcast channel content with currently broadcast channel content with VOD and advanced navigation patterns can reduce traditional TV broadcast limitations. Displaying previously broadcast content on a particular channel, without scheduling, at the same time as watching live broadcast content on the same channel can transform a traditional channel from one direction of navigation to a dynamic channel having multiple directions of navigation. For instance, content can be chosen inside the channel by using algorithms for episode grouping or by using algorithms to watch all episodes of a particular show one-by-one as well as grouping into collections by time of broadcast, genre, tag, particular show, location of origin, person involved, etc.

The smart channel can allow for selection and viewing of a program that was on the smart channel previously and make the program available for additional playbacks. Furthermore, the smart channel can display a schedule of future programs and allow the user to set a reminder associated with a selected program. The reminder can then notify the user prior to the program going live, when the program goes live, or shortly thereafter the program has gone live. The smart channel can be programmed based on a user preference for watching video content. The smart channel can also allow the user to ban, delete, or skip recorded or currently broadcast video content, which the user would like to exclude from the channel. The exclusion of certain broadcast content can be predicated upon, but is not limited to, topics, keywords, and broadcast times. The smart channel can be programmed to render all episodes, one-by-one, that are available on the smart channel and were broadcasted within a specific time frame. The smart channel can have multiple paths for navigating the contents within. For instance, the smart channel can group episodes of a specific franchise and display them and provide an option to filter each episode by a particular character.

The smart channel can allow for manual or automatic fragmentation of video content within the channel by partitioning the video content and applying metadata. The metadata can include, but is not limited to, text, pictures, videos, and user generated metadata. Further, the video content can be identified via an external metadata source and/or timestamps within the smart channel itself. Metadata can be applied to the video content and/or the smart channel itself, where the smart channel metadata can include, but is not limited to, descriptions, video fragments, etc.

The smart channel can also allow for a fast-forwarded view of currently broadcast video content, a rewound view of the currently broadcasted video content, an on-demand view of previously broadcasted video content, and/or featured video content associated with the smart channel.

Time-shifted content of the smart channel can loop like a circular or linear feed within a certain time period, allowing for a selection of any video content in the feed. The feed can automatically update by deleting old video content or add new video content as soon as the video content goes live or live video content becomes available for VOD. If the video content is available live, but not allowed on demand, it can disappear from feed as soon as the live broadcast is finished.

The smart channel can also be promoted, using video content snippets and/or its metadata, within the smart channel service or other channels. The smart channel can allow video content tagging within the channel, including but not limited to, editorials, closed captions, subtitles, speech to text, text to speech, etc. Tagging can also include prioritizing the video content by topics and by keywords from the channel audio track.

Metadata can be used to personalize the smart channel. The smart channel can also be personalized via a user's watching history and preferences. The smart channel can also be customized based on what a user is not watching or what video content the user has skipped. Viewing behavior such as viewing a series of related video content, time a viewing took place, or frequency of viewing can be recorded and analyzed either separately or in combination to create a personalized viewing experience. The user can also explicitly tag video content, as liked or disliked, to further the smart channel's analysis of viewing behavior. The user can dictate how video content should be rendered. For instance, the user can define what video content the smart channel should render next.

Analysis of data associated with user viewing behavior can be used to suggest or provide options for viewing video content related to the data associated with the user viewing behavior. User viewing behavior and personalization of the smart channel can be associated with a user identification method, including but not limited to, user logins, passwords, face recognition, biometrics, mobile device pairing, device identification authentication, etc.

In one embodiment, described herein is a method for terminating a smart channel rendering of previously broadcast content and initiating smart channel live broadcast content. The smart channel can also display options for selection of the previously broadcast content or the live broadcast content.

According to another embodiment, described herein is an apparatus for receiving input from a device to switch a currently broadcast content item to a previously broadcast content item. The apparatus can also display options for selection of the previously broadcast content item or the live broadcast content item.

According to another embodiment, an article of manufacture, such as a computer readable storage medium or the like, can store instructions that, when executed by a computing device, can facilitate initiation of terminating a smart channel rendering of a live broadcast content item and receiving input to select a rendering of a smart channel previously broadcast content item.

These and other embodiments or implementations are described in more detail below with reference to the drawings.

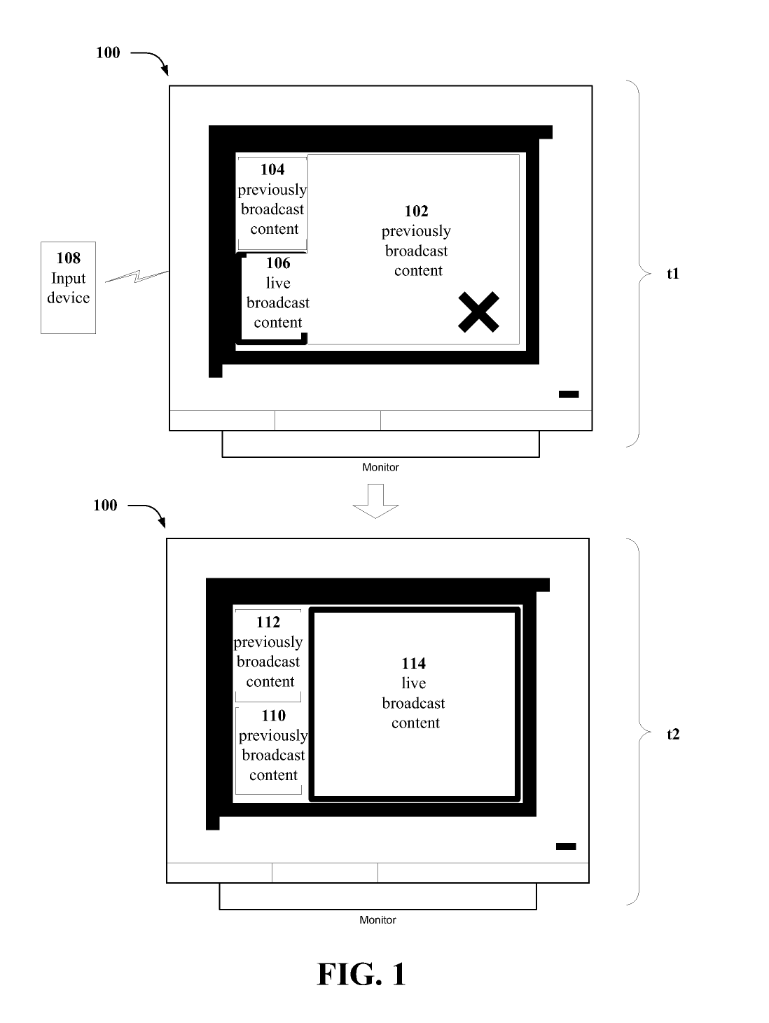

Referring now to FIG. 1, illustrated an exemplary rendering of multiple broadcast content at time t1 and time t2 where live broadcast content 106 at time t1 is selected as the live broadcast content 114 primary display at time t2. Previously broadcast content 104, live broadcast content 106, and previously broadcast content 102 at time t1 represent previously broadcast content 112, live broadcast content 114, and previously broadcast content 110 at time t2, respectively.

The monitor 100 can be any display including, but not limited to, TV screens, laptops, desktop computers, etc. The monitor 100 can render a primary display and a secondary display where the primary display can render selected content and the secondary display can render content for selection. At time t1, the primary display can render previously broadcast content 102 and the secondary display can render previously broadcast content 104 and live broadcast content 106.

Input device 108 can be used to select and terminate rendered content. Input device 108 can be attached to or external to monitor 100. The input device 108 can connect to the monitor 100 via any wireless means including, but not limited to, radio frequency (RF) signals, the internet, infra red, Wi-Fi, Bluetooth, 3G, 4G, or the like. As represented by FIG. 1, selection of the live broadcast content 106, by the input device 108, can terminate the previously broadcast content 102 at time t1. Selection of the live broadcast content 106 and termination of the previously broadcast content 102 at time t1 can then render a display of the live broadcast content 114 on the primary display at time t2. Selection of the live broadcast content 106 and termination of the previously broadcast content 102 at time t1 can also cause the previously broadcast content 110 to be displayed on the secondary display at time t2, where previously broadcast content 110 is represented by previously broadcast content 102 at time t1.

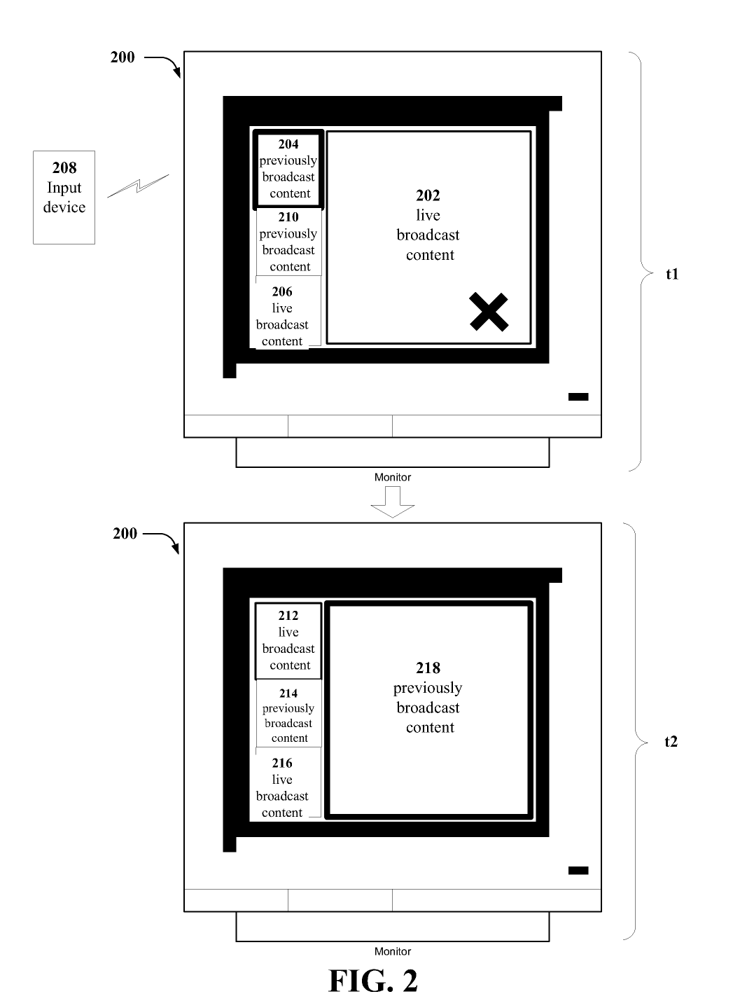

Referring now to FIG. 2, illustrated is an exemplary rendering of multiple broadcast content at time t1 and time t2 where previously broadcast content is selected for the primary display at time t2. Previously broadcast content 204, live broadcast content 206, previously broadcast content 210, and live broadcast content 202 at time t1 represent previously broadcast content 218, live broadcast content 216, previously broadcast content 214, and live broadcast 212 at time t2, respectively.

The monitor 200 can be any display including, but not limited to, TV screens, laptops, desktop computers, etc. The monitor 200 can render a primary display and a secondary display where the primary display can render selected content and the secondary display can render content for selection. At time t1, the primary display can render live broadcast content 202 and the secondary display can render previously broadcast content 204, previously broadcast content 210, and live broadcast content 206.

Input device 208 can be used to select and terminate rendered content. Input device 208 can be attached to or external to monitor 200. The input device 208 can connect to the monitor 200 via any wireless means including, but not limited to, radio frequency (RF) signals, the internet, Wi-Fi, Bluetooth, 3G, 4G, or the like. As represented by FIG. 2, selection of the previously broadcast content 204, by the input device 208, can terminate the live broadcast content 202 at time t1. Selection of the previously broadcast content 204 and termination of the live broadcast content 202 at time t1 can then display a rendering of the previously broadcast content 218 on the primary display at time t2. Selection of the previously broadcast content 204 and termination of the live broadcast content 202 at time t1 can also cause the live broadcast content 212 to be displayed on the secondary display at time t2, where live broadcast content 212 is represented by live broadcast content 202 at t1.

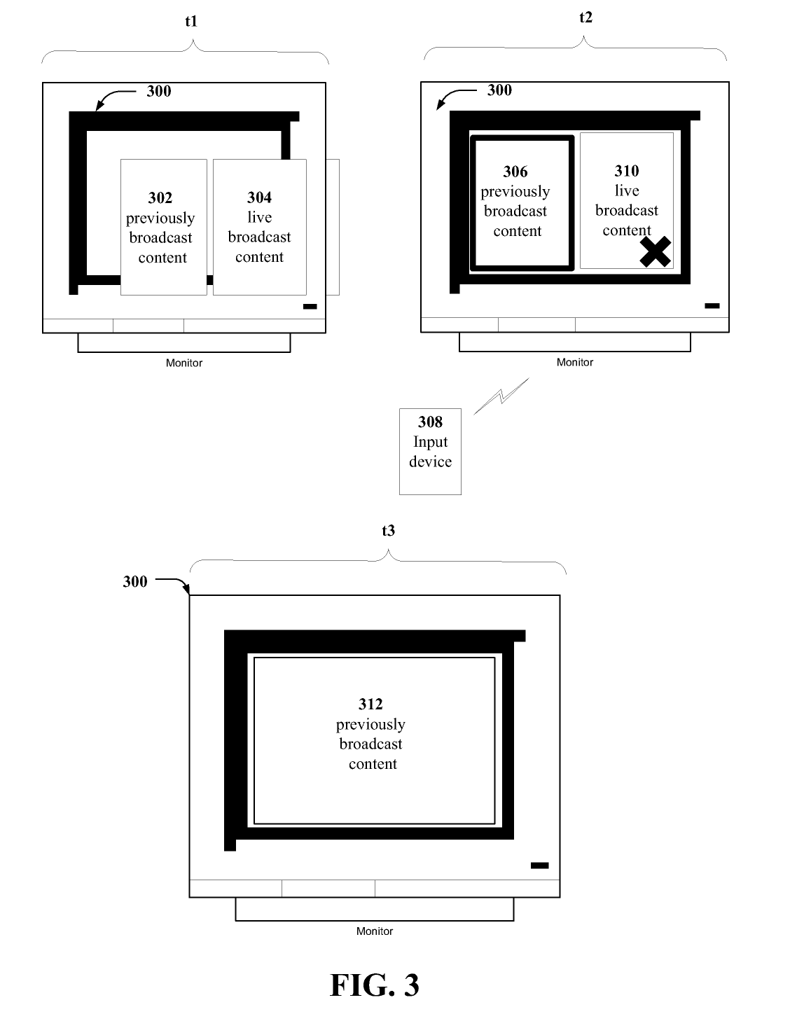

Referring now to FIG. 3, illustrated is an exemplary rendering of broadcast content on a separate secondary display at time t1, where previously broadcast content is selected at time t2, and where the primary display renders the previously broadcast content at time t3. The primary display and the secondary display can be separated so that they are not displayed concurrently. Previously broadcast content 302 and live broadcast content 304 at time t1 can represent previously broadcast content 306 and live broadcast content 310 at time t2, respectively. Further, previously broadcast content 306 at time t2 can represent previously broadcast content 312 at time t3.

The monitor 300 can be any display including, but not limited to, TV screens, laptops, desktop computers, etc. The monitor 300 can render a primary display and a secondary display, as two separate displays, where the primary display can render selected content and the secondary display can render content for selection. For instance, at time t1 the secondary display can render previously broadcast content 302 and live broadcast content 304 for selection. Furthermore, the secondary display can render previously broadcast content 306 and live broadcast content 310 for selection at time t2, where previously broadcast content 306 is being selected.

Input device 308 can be used to select and terminate rendered content as shown at time t2. Input device 308 can be attached to or external to monitor 300. The input device 308 can connect to the monitor 300 via any wireless means including, but not limited to, radio frequency (RF) signals, the internet, Wi-Fi, Bluetooth, 3G, 4G, or the like. As represented by FIG. 3 at time t2, selection of the previous broadcast content 306, by the input device 308, can terminate the live broadcast content 310. Selection of the previously broadcast content 306 and termination of the live broadcast content 310 at time t2 can then render a separate display of the previously broadcast content 312 on the primary display at time t3. Consequently, the primary display screen at time t3 is determined by the selection of a content item within the secondary display at time t2.

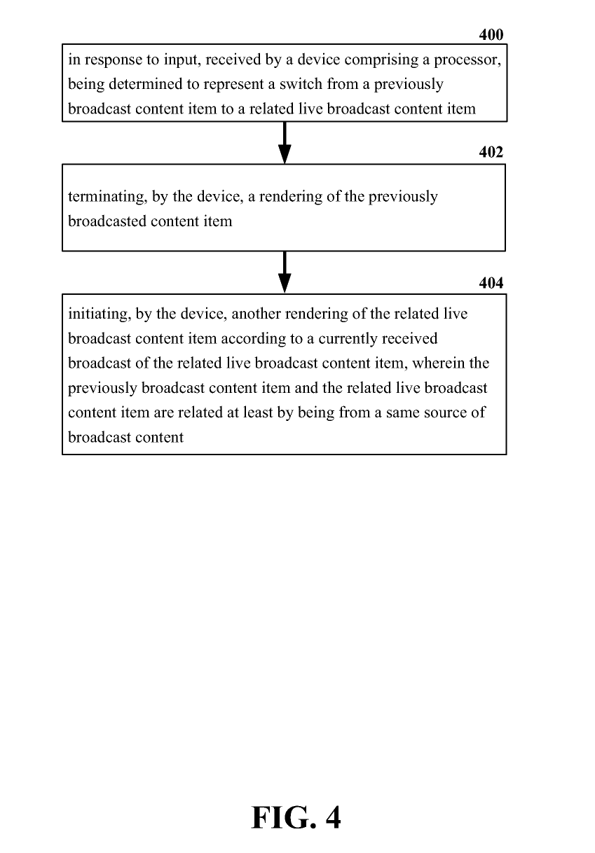

Referring now to FIG. 4, illustrated is a schematic process flow diagram of a method for terminating previously broadcast content and rendering live broadcast content. At element 400, in response to an input, received by a device comprising a processor, a display switches from a previously broadcast content item to a related live broadcast content item.

The display screen can include, but is not limited to, monitors, TV screens, laptops, desktop computers, etc. The display screen can render a primary display and a secondary display, as two separate displays, where the primary display can render selected content and the secondary display can render content for selection. For instance, at time t1 the secondary display can render previously broadcast content and live broadcast content for selection. Furthermore, the secondary display can render previously broadcast content and live broadcast content for selection at time t2.

At element 402 a rendering of the previously broadcasted content item can be terminated. An input device can be used to select and terminate rendered content. The input device can be attached to or external to the display screen. The input device can connect to the display screen via any wireless means including, but not limited to, radio frequency (RF) signals, the internet, infra red, Wi-Fi, Bluetooth, 3G, 4G, or the like. The input device can also be used to initiate another rendering of the related live broadcast content item, at element 404, according to a currently received broadcast of the related live broadcast content item, wherein the previously broadcast content item and the related live broadcast content item are related at least by being from a same source of broadcast content. The previously broadcast content item and the live broadcast content item can be related or associated with a particular channel by other factors including, but not limited to: metadata, preference, time, etc.

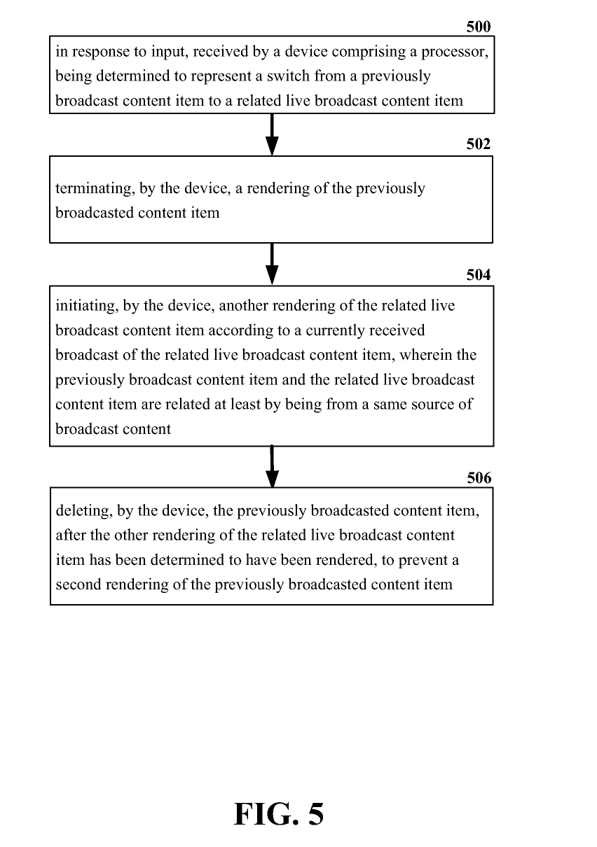

Referring now to FIG. 5, illustrated is a schematic process flow diagram of a method for terminating previously broadcast content, rendering live broadcast content, and deleting the previously broadcast content. At element 500, in response to an input, received by a device comprising a processor, a display switches from a previously broadcast content item to a related live broadcast content item comprising.

The display screen can include, but is not limited to, monitors, TV screens, laptops, desktop computers, etc. The display screen can render a primary display and a secondary display, as two separate displays, where the primary display can render selected content and the secondary display can render content for selection. For instance, at time t1 the secondary display can render previously broadcast content and live broadcast content for selection. Furthermore, the secondary display can render previously broadcast content and live broadcast content for selection at time t2.

At element 502 a rendering of the previously broadcasted content item can be terminated. An input device can be used to select and terminate rendered content. The input device can be attached to or external to the display screen. The input device can connect to the display screen via any wireless means including, but not limited to, radio frequency (RF) signals, the internet, infra red, Wi-Fi, Bluetooth, 3G, 4G, or the like. The input device can also be used to initiate another rendering of the related live broadcast content item, at element 504, according to a currently received broadcast of the related live broadcast content item, wherein the previously broadcast content item and the related live broadcast content item are related at least by being from a same source of broadcast content. The previously broadcast content item and the live broadcast content item can be related or associated with a particular channel by factors including, but not limited to: metadata, preference, time, etc.

At element 506 the previously broadcasted content item can be deleted after the other rendering of the related live broadcast content item has been determined to have been rendered, to prevent a second rendering of the previously broadcasted content item. A feed can automatically update by deleting old TV video content as soon as the video content goes live or live video content becomes available for VOD. If the video content is available live, but not allowed on-demand, it can disappear from the feed as soon as a live broadcast is finished.

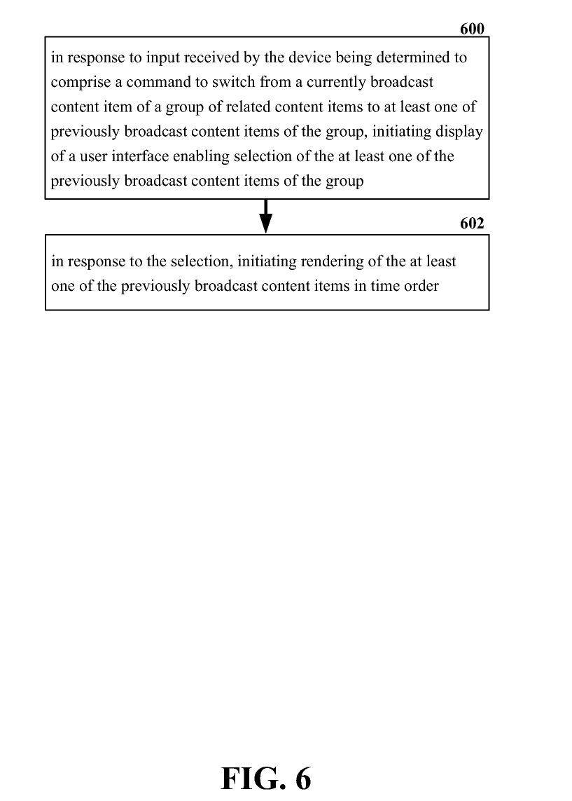

Referring now to FIG. 6, illustrated is a schematic process flow diagram of a device switching from a currently broadcast content to a previously broadcast content and initiating a rendering of the previously broadcast content. At element 600 in response to input received, a device can switch from a currently broadcast content item of a group of related content items to at least one of previously broadcast content items of the group, initiating display of a user interface enabling selection of the at least one of the previously broadcast content items of the group. The previously broadcast content item and the currently broadcast content item can be related or associated with a particular channel by factors including, but not limited to: metadata, preference, time, etc.

The device can comprise a display screen that can include, but is not limited to, monitors, TV screens, laptops, desktop computers, etc. The display screen can render a primary display and a secondary display, as two separate displays, where the primary display can render selected content and the secondary display can render content for selection. For instance, at time t1 the secondary display can render previously broadcast content and currently broadcast content for selection. Furthermore, the secondary display can render previously broadcast content and live broadcast content for selection at time t2.

An input device can be used to select and terminate rendered content. The input device can be attached to or external to the display screen. The input device can connect to the display screen via any wireless means including, but not limited to, radio frequency (RF) signals, the internet, infra red, Wi-Fi, Bluetooth, 3G, 4G, or the like.

At element 602, in response to the selection at element 600, rendering of the at least one of the previously broadcast content items in time order is initiated. Time-shifted content of the a smart channel can loop like a feed within a certain time period, allowing for a selection of any video content in the circled feed or linear feed. Further, the video content can be identified via an external metadata source and/or timestamps within the smart channel itself. Viewing behavior such as viewing a series of related video content, time a viewing took place, or frequency of viewing can be recorded and analyzed either separately or in combination to create a personalized viewing experience.

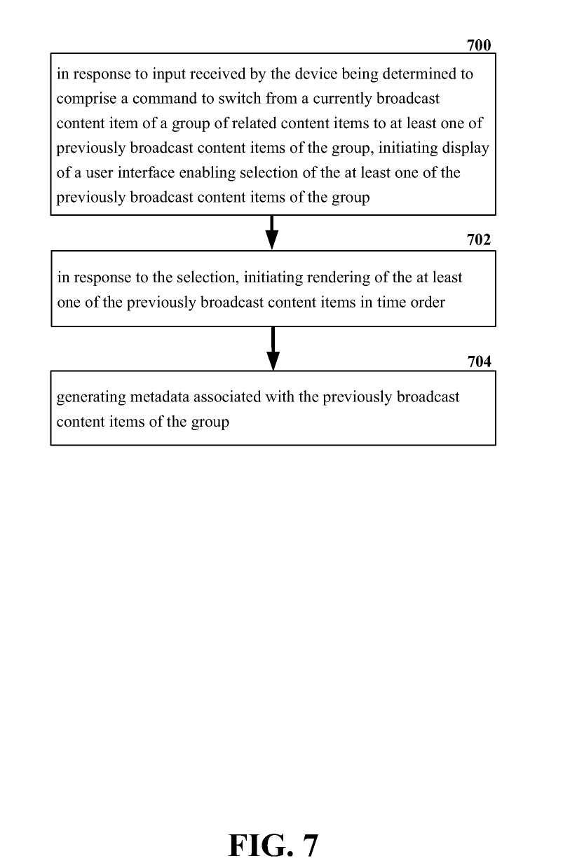

Referring now to FIG. 7, illustrated is a schematic process flow diagram of a device switching from a currently broadcast content to a previously broadcast content, initiating a rendering of the previously broadcast content, and generating metadata. At element 700 in response to input received, a device can switch from a currently broadcast content item of a group of related content items to at least one of previously broadcast content items of the group, initiating display of a user interface enabling selection of the at least one of the previously broadcast content items of the group. The previously broadcast content item and the currently broadcast content item can be related or associated with a particular channel by factors including, but not limited to: metadata, preference, time, etc.

The device can comprise a display screen that can include, but is not limited to, monitors, TV screens, laptops, desktop computers, etc. The display screen can render a primary display and a secondary display, as two separate displays, where the primary display can render selected content and the secondary display can render content for selection. For instance, at time t1 the secondary display can render previously broadcast content and currently broadcast content for selection. Furthermore, the secondary display can render previously broadcast content and live broadcast content for selection at time t2.

An input device can be used to select and terminate rendered content. The input device can be attached to or external to the display screen. The input device can connect to the display screen via any wireless means including, but not limited to, radio frequency (RF) signals, the internet, infra red, Wi-Fi, Bluetooth, 3G, 4G, or the like.

At element 702, in response to the selection at element 700, a rendering of the at least one of the previously broadcast content items in time order is initiated. Time-shifted content of the a smart channel can loop like a feed within a certain time period, allowing for a selection of any video content in the feed. Further, the video content can be identified via an external metadata source and/or timestamps within the smart channel itself. Viewing behavior such as viewing a series of related video content, time a viewing took place, or frequency of viewing can be recorded and analyzed either separately or in combination to create a personalized viewing experience.

At element 704, metadata associated with the previously broadcast content items can be generated. The previous broadcast content can be split into pieces of content, enriched by metadata and presented as on-demand video content, where a selection of any piece of content available on the channel can be made. The smart channel can allow for manual or automatic fragmentation of video content within the channel by partitioning the video content and applying metadata. Further, the video content can be identified via an external metadata source and/or timestamps within the smart channel itself.

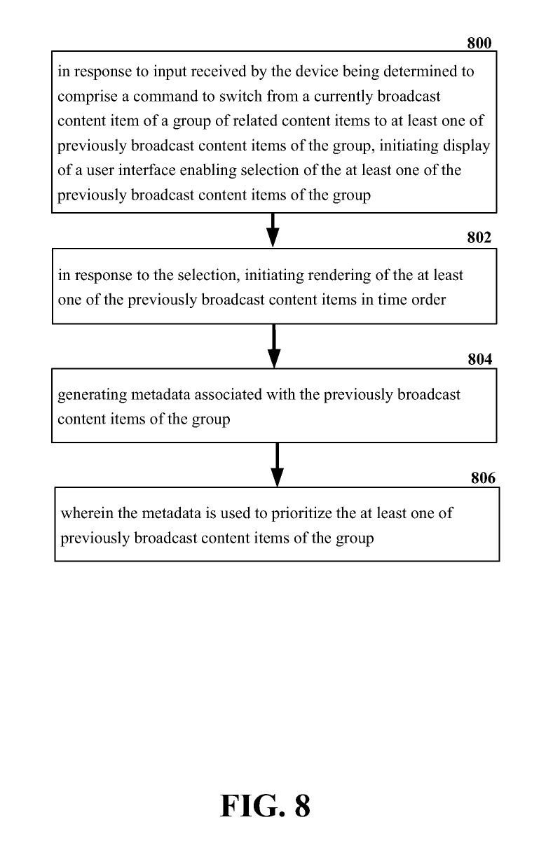

Referring now to FIG. 8, illustrated is a schematic process flow diagram of a device switching from a currently broadcast content to a previously broadcast content, initiating a rendering of the previously broadcast content, generating metadata, and using the metadata to prioritize broadcast content. At element 800 in response to input received, a device can switch from a currently broadcast content item of a group of related content items to at least one of previously broadcast content items of the group, initiating display of a user interface enabling selection of the at least one of the previously broadcast content items of the group. The previously broadcast content item and the currently broadcast content item can be related or associated with a particular channel by factors including, but not limited to: metadata, preference, time, etc.

The device can comprise a display screen that can include, but is not limited to, monitors, TV screens, laptops, desktop computers, etc. The display screen can render a primary display and a secondary display, as two separate displays, where the primary display can render selected content and the secondary display can render content for selection. For instance, at time t1 the secondary display can render previously broadcast content and currently broadcast content for selection. Furthermore, the secondary display can render previously broadcast content and live broadcast content for selection at time t2.

An input device can be used to select and terminate rendered content. The input device can be attached to or external to the display screen. The input device can connect to the display screen via any wireless means including, but not limited to, radio frequency (RF) signals, the internet, infra red, Wi-Fi, Bluetooth, 3G, 4G, or the like.

At element 802, in response to the selection at element 800, a rendering of the at least one of the previously broadcast content items in time order is initiated. Time-shifted content of the a smart channel can loop like a feed within a certain time period, allowing for a selection of any video content in the feed. Further, the video content can be identified via an external metadata source and/or timestamps within the smart channel itself. Viewing behavior such as viewing a series of related video content, time a viewing took place, or frequency of viewing can be recorded and analyzed either separately or in combination to create a personalized viewing experience.

At element 804, metadata associated with the previously broadcast content items can be generated. The previous broadcast content can be split into pieces of content, enriched by metadata and presented as on-demand video content, where a selection to watch any piece of content available on the channel can be made. The smart channel can allow for manual or automatic fragmentation of video content within the channel by partitioning the video content and applying metadata. Further, the video content can be identified via an external metadata source and/or timestamps within the smart channel itself. The metadata of element 804 can be used to prioritize the at least one of the previously broadcast content items of the group at element 806.

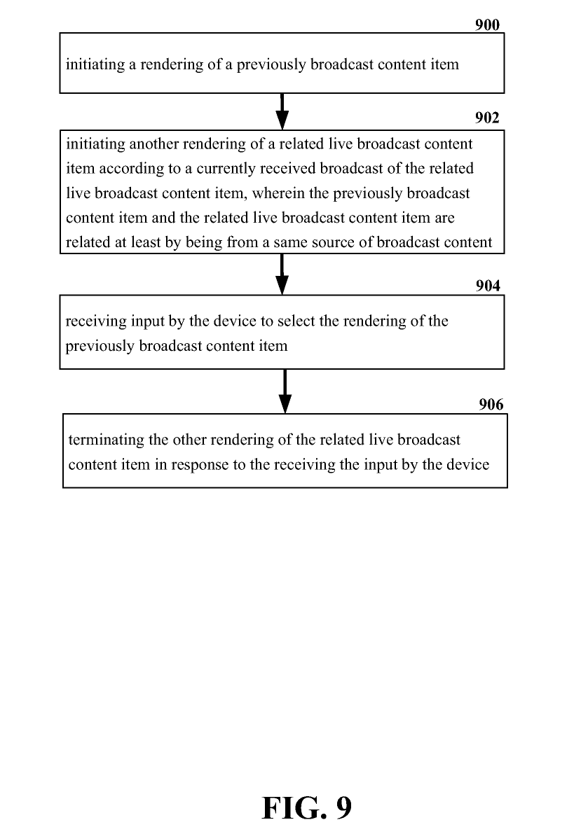

Referring now to FIG. 9, illustrated is a schematic process flow diagram of a computer readable storage medium for rendering a previously broadcast content item, rendering a live broadcast item, selecting the previous broadcast content item, and terminating the live broadcast. At element 900 a rendering of a previously broadcast content item can be initiated. At element 902, another rendering of a related live broadcast content item according to a currently received broadcast of the related live broadcast content item, wherein the previously broadcast content item and the related live broadcast content item are related at least by being from a same source of broadcast content can be initiated.

An input device can be used to select and terminate rendered content. The input device can be attached to or external to a display screen. The input device can communicate with the storage medium via any wireless means including, but not limited to, radio frequency (RF) signals, the internet, infra red, Wi-Fi, Bluetooth, 3G, 4G, or the like. At element 904 the storage medium can receive input from the input device to select the rendering of the previously broadcast content item. In response to the receiving the input by the device at element 906, the other rendering of the related live broadcast can be terminated.

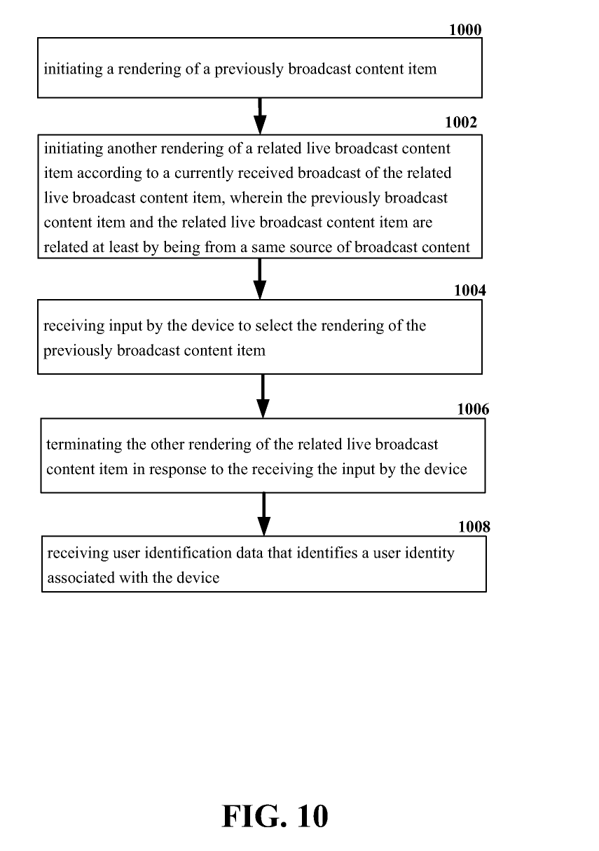

Referring now to FIG. 10, illustrated is a schematic process flow diagram of a computer readable storage medium for rendering a previously broadcast content item, rendering a live broadcast item, selecting the previous broadcast content item, terminating the live broadcast and receiving user identification data. At element 1000 a rendering of a previously broadcast content item can be initiated. At element 1002, another rendering of a related live broadcast content item according to a currently received broadcast of the related live broadcast content item, wherein the previously broadcast content item and the related live broadcast content item are related at least by being from a same source of broadcast content can be initiated.

An input device can be used to select and terminate rendered content. The input device can be attached to or external to a display screen. The input device can communicate with the storage medium via any wireless means including, but not limited to, radio frequency (RF) signals, the internet, infra red, Wi-Fi, Bluetooth, 3G, 4G, or the like. At element 1004 the storage medium can receive input from the input device to select the rendering of the previously broadcast content item. In response to the receiving the input by the device at element 1006, the other rendering of the related live broadcast can be terminated. At element 1008, user identification can be received. User viewing behavior and personalization of a smart channel can be associated with a user identification method, including but not limited to, user logins, passwords, face recognition, biometric, mobile device pairing, device identification ID etc.

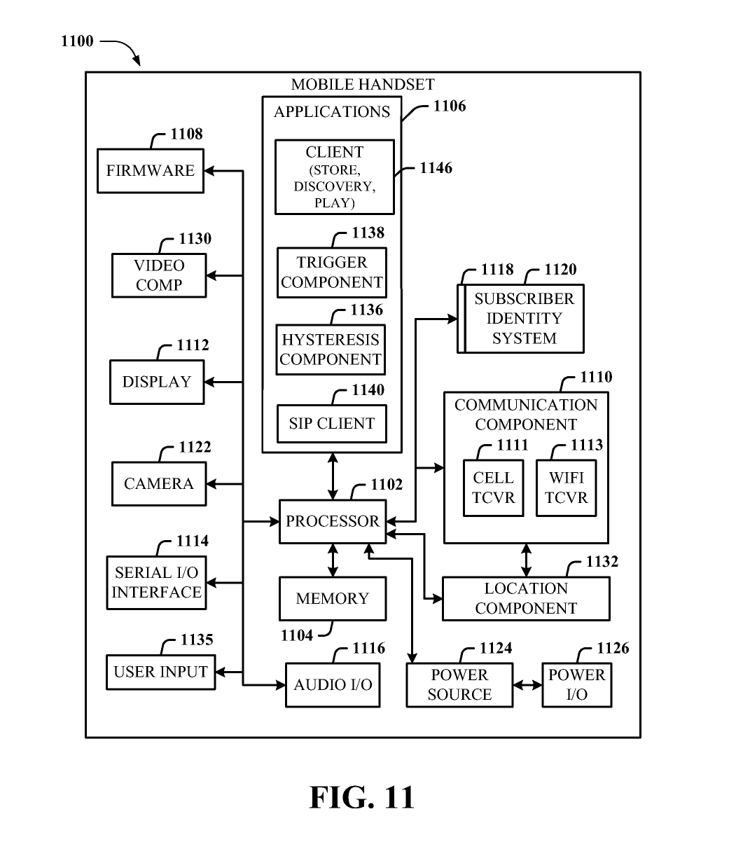

Referring now to FIG. 11, illustrated is a schematic block diagram of an exemplary end-user device such as a mobile device 1100 capable of connecting to a network in accordance with some embodiments described herein. Although a mobile handset 1100 is illustrated herein, it will be understood that other devices can be a mobile device, and that the mobile handset 1100 is merely illustrated to provide context for the embodiments of the innovation described herein. The following discussion is intended to provide a brief, general description of an example of a suitable environment 1100 in which the various embodiments can be implemented. While the description includes a general context of computer-executable instructions embodied on a computer readable storage medium, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer-readable media. Computer readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1100 includes a processor 1102 for controlling and processing all onboard operations and functions. A memory 1104 interfaces to the processor 1102 for storage of data and one or more applications 1106 (e.g., a video player software, user feedback component software, etc.). Other applications can include voice recognition of predetermined voice commands that facilitate initiation of the user feedback signals. The applications 1106 can be stored in the memory 1104 and/or in a firmware 1108, and executed by the processor 1102 from either or both the memory 1104 or/and the firmware 1108. The firmware 1108 can also store startup code for execution in initializing the handset 1100. A communications component 1110 interfaces to the processor 1102 to facilitate wired/wireless communication with external systems, e.g., cellular networks, VoIP networks, and so on. Here, the communications component 1110 can also include a suitable cellular transceiver 1111 (e.g., a GSM transceiver) and/or an unlicensed transceiver 1113 (e.g., WiFi, WiMax) for corresponding signal communications. The handset 1100 can be a device such as a cellular telephone, a PDA with mobile communications capabilities, a television, a tablet, a computer, a set-top box (STB), and messaging-centric devices. The communications component 1110 also facilitates communications reception from terrestrial radio networks (e.g., broadcast), digital satellite radio networks, and Internet-based radio services networks.

The handset 1100 includes a display 1112 for displaying text, images, video, telephony functions (e.g., a Caller ID function), setup functions, and for user input. For example, the display 1112 can also be referred to as a “screen” that can accommodate the presentation of multimedia content (e.g., music metadata, messages, wallpaper, graphics, etc.). The display 1112 can also display videos and can facilitate the generation, editing and sharing of video quotes. A serial I/O interface 1114 is provided in communication with the processor 1102 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1100, for example. Audio capabilities are provided with an audio I/O component 1116, which can include a speaker for the output of audio signals related to, for example, indication that the user pressed the proper key or key combination to initiate the user feedback signal. The audio I/O component 1116 also facilitates the input of audio signals through a microphone to record data and/or telephony voice data, and for inputting voice signals for telephone conversations.

The handset 1100 can include a slot interface 1118 for accommodating a SIC (Subscriber Identity Component) in the form factor of a card Subscriber Identity Module (SIM) or universal SIM 1120, and interfacing the SIM card 1120 with the processor 1102. However, it is to be appreciated that the SIM card 1120 can be manufactured into the handset 1100, and updated by downloading data and software.

The handset 1100 can process IP data traffic through the communication component 1110 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 1122 (e.g., a camera) can be provided for decoding encoded multimedia content. The video processing component 1122 can aid in facilitating the generation, editing and sharing of video quotes. The handset 1100 also includes a power source 1124 in the form of batteries and/or an AC power subsystem, which power source 1124 can interface to an external power system or charging equipment (not shown) by a power I/O component 1126.

The handset 1100 can also include a video component 1130 for processing video content received and, for recording and transmitting video content. For example, the video component 1130 can facilitate the generation, editing and sharing of video quotes. A location tracking component 1132 facilitates geographically locating the handset 1100. As described hereinabove, this can occur when the user initiates the feedback signal automatically or manually. A user input component 1134 facilitates the user initiating the quality feedback signal. The user input component 1134 can also facilitate the generation, editing and sharing of video quotes. The user input component 1134 can include such conventional input device technologies such as a keypad, keyboard, mouse, stylus pen, and/or touch screen, for example.

Referring again to the applications 1106, a hysteresis component 1136 facilitates the analysis and processing of hysteresis data, which is utilized to determine when to associate with the access point. A software trigger component 1138 can be provided that facilitates triggering of the hysteresis component 1138 when the WiFi transceiver 1113 detects the beacon of the access point. A SIP client 1140 enables the handset 1100 to support SIP protocols and register the subscriber with the SIP registrar server. The applications 1106 can also include a client 1142 that provides at least the capability of discovery, play and store of multimedia content, for example, music.

The handset 1100, as indicated above related to the communications component 810, includes an indoor network radio transceiver 1113 (e.g., WiFi transceiver). This function supports the indoor radio link, such as IEEE 802.11, for the dual-mode GSM handset 1100. The handset 1100 can accommodate at least satellite radio services through a handset that can combine wireless voice and digital radio chipsets into a single handheld device.

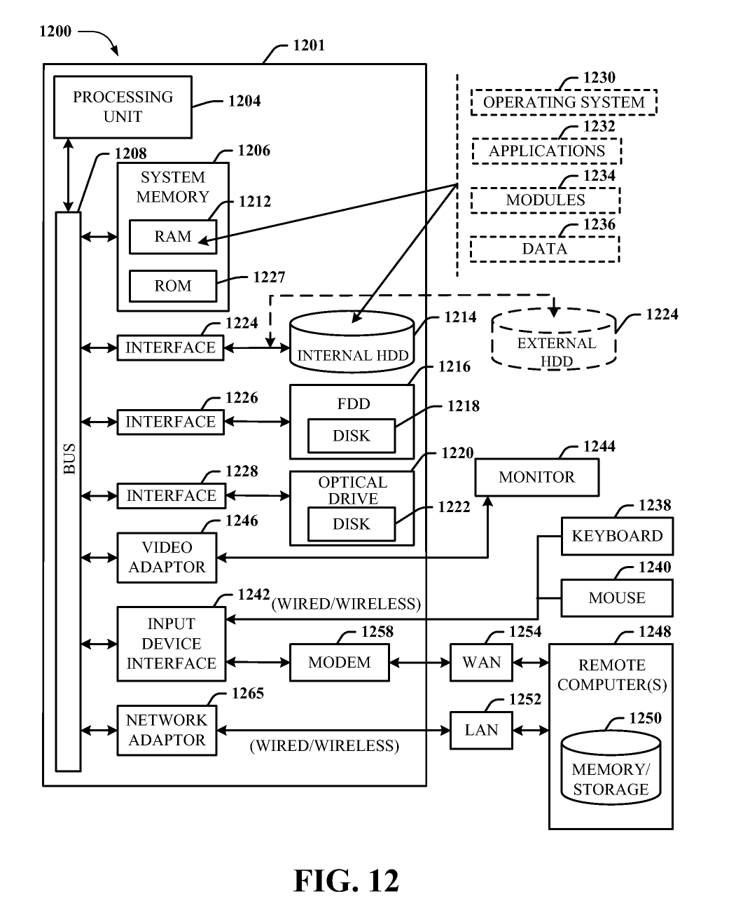

Referring now to FIG. 12, there is illustrated a block diagram of a computer 1200 operable to execute a system architecture that facilitates establishing a transaction between an entity and a third party. The computer 1200 can provide networking and communication capabilities between a wired or wireless communication network and a server and/or communication device. In order to provide additional context for various aspects thereof, FIG. 12 and the following discussion are intended to provide a brief, general description of a suitable computing environment in which the various aspects of the innovation can be implemented to facilitate the establishment of a transaction between an entity and a third party. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media can embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference to FIG. 12, implementing various aspects described herein with regards to the end-user device can include a computer 1200, the computer 1200 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1200, such as during start-up. The RAM 1212 can also include a high-speed RAM such as static RAM for caching data.

The computer 1200 further includes an internal hard disk drive (HDD) 1214 (e.g., EIDE, SATA), which internal hard disk drive 1214 can also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1211 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1294 interface technologies. Other external drive connection technologies are within contemplation of the subject innovation.

The drives and their associated computer-readable media provide nonvolatile storage of data, data structures, computer-executable instructions, and so forth. For the computer 1200 the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer 1200, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is to be appreciated that the innovation can be implemented with various commercially available operating systems or combinations of operating systems.

A user can enter commands and information into the computer 1200 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 2394 serial port, a game port, a USB port, an IR interface, etc.

A monitor 1244 or other type of display device is also connected to the system bus 1208 through an interface, such as a video adapter 1246. In addition to the monitor 1244, a computer 1200 typically includes other peripheral output devices (not shown), such as speakers, printers, etc.

The computer 1200 can operate in a networked environment using logical connections by wired and/or wireless communications to one or more remote computers, such as a remote computer(s) 1248. The remote computer(s) 1248 can be a workstation, a server computer, a router, a personal computer, portable computer, microprocessor-based entertainment device, a peer device or other common network node, and typically includes many or all of the elements described relative to the computer, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1200 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1200 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 through the serial port interface 1242. In a networked environment, program modules depicted relative to the computer, or portions thereof, can be stored in the remote memory/storage device 1250. It will be appreciated that the network connections shown are exemplary and other means of establishing a communications link between the computers can be used.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE 802.11 (a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

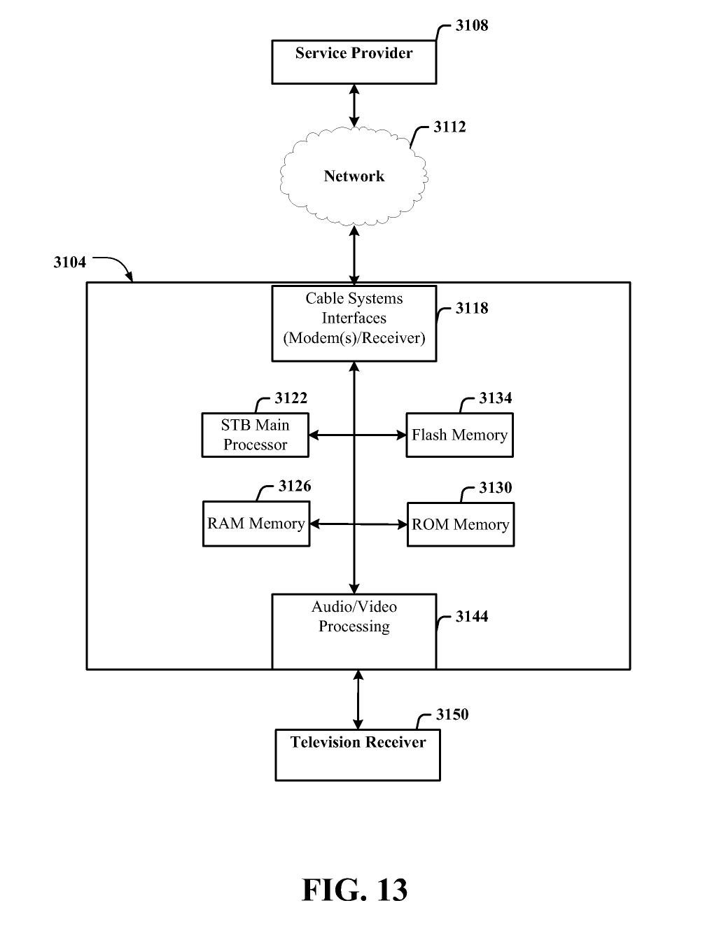

Turning now to FIG. 13, a simplified block diagram of an exemplary cable television arrangement 3100 with a set-top box 3104 is illustrated. An STB is an electronic device that is connected to a communication channel, such as a phone, ISDN or cable television line, and produces output on a conventional television screen. STBs are commonly used to receive and decode digital television broadcasts and to interface with the Internet through the user's television instead of a PC. STBs fall into several categories, from the simplest that receive and unscramble incoming television signals to the more complex that will also function as multimedia desktop computers that can run a variety of advanced services such as videoconferencing, home networking, IP telephony, video-on-demand (VoD) and high-speed Internet TV services.

The STB 3104 can connect to a cable system service provider 3108 via a cable network 3112. An interface to the cable system is provided at STB 3104 in the form of a television receiver (tuner) as well as potentially in-band and out-of-band modems, collectively shown as interfaces 3118. STB 3104 can incorporate an internal main processor 3122 with associated RAM memory 3126, ROM memory 3130 and FLASH memory 3134. The processor 3122 can be interconnected with the associated memory in a conventional manner using a single or multiple bus connections depicted as 3138. Audio and video information is processed using audio/video (A/V) processing circuitry 3144 that receives such A/V signals from the cable system interface 3118. The processed A/V information can then be delivered to a television receiver 3150 or a monitor and audio system for presentation to the user.

While the above exemplary system including STB 3104 is illustrative of the basic components of a digital STB suitable for use with the present invention, the architecture shown should not be considered limiting since many variations of the hardware configuration are possible without departing from the present invention. For instance, the components of an STB can be found within a dongle, connected to a display source, used to facilitate STB functionality. It is anticipated that many functions of the STB 3104 will be incorporated into various television receiver devices themselves (e.g., the television set, a personal video recorder (PVR) or a video tape recorder (VTR)). Accordingly, the present invention contemplates such embodiments as fully equivalent to the STB environment of the exemplary embodiment.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
in response to input, received by a device comprising a processor, being determined to represent a switch from a previously broadcast content item to a related live broadcast content item,
terminating, by the device, a rendering of the previously broadcasted content item; and
initiating, by the device, another rendering of the related live broadcast content item according to a currently received broadcast of the related live broadcast content item, wherein the previously broadcast content item and the related live broadcast content item are related at least by being from a same source of broadcast content.

2. The method of claim 1, further comprising:
deleting, by the device, the previously broadcasted content item, after the other rendering of the related live broadcast content item has been determined to have been rendered, to prevent a second rendering of the previously broadcasted content item.

3. The method of claim 1, further comprising:
partitioning, by the device, the rendering of the previously broadcasted content item.

4. The method of claim 3, further comprising:
tagging, by the device, the rendering of the previously broadcasted content item.

5. The method of claim 4, further comprising:
grouping, by the device, a partitioned previously broadcasted content item with another partitioned previously broadcasted content item based on a tag applicable to the partitioned previously broadcasted content item and the other partitioned previously broadcasted content item, wherein the grouping is based on a time of broadcast, a genre, a show title, a location of origin, or a character.

6. The method of claim 5, further comprising:
initiating, by the device, a rendering of a group of previously broadcasted content items, wherein the group of previously broadcasted content items comprises the partitioned previously broadcasted content item and the other partitioned previously broadcasted content item.

7. The method of claim 3, wherein the partitioning is based on metadata associated with the previously broadcasted content item.

8. A device, comprising:
a processor, coupled to a memory, that executes or facilitates execution of executable instructions to perform operations, comprising:
in response to input received by the device being determined to comprise a command to switch from a currently broadcast content item of a group of related content items to at least one of previously broadcast content items of the group, initiating display of a user interface enabling selection of the at least one of the previously broadcast content items of the group; and
in response to the selection, initiating rendering of the at least one of the previously broadcast content items in time order.

9. The device of claim 8, wherein the operations further comprise:
generating metadata associated with the previously broadcast content items of the group.

10. The device of claim 9, wherein the metadata is used to prioritize the at least one of the previously broadcast content items of the group.

11. The device of claim 8, wherein the initiating the rendering of the at least one of the previously broadcast content items in time order is based, at least in part, on preference data representing a preference of a time of broadcast, a genre, a show title, a location of origin, or a character.

12. The device of claim 8, wherein the initiating the display of the user interface enabling the selection of the at least one of the previously broadcast content items of the group is based, at least in part, on channel history data representing a history of channels displayed by the device.

13. The device of claim 8, wherein the display of the user interface comprises recommendation information representing a suggestion based on the currently broadcast content item.

14. The device of claim 8, wherein the previously broadcast content items comprise respective timestamps associated with respective times that the previously broadcast content items were previously broadcast and a tag associated with a time of broadcast, a genre, a show title, a location of origin, or a character.

15. A non-transitory computer readable medium having instructions stored thereon that, in response to execution, cause a device comprising a processor to perform operations, comprising:
initiating a rendering of a previously broadcast content item;
initiating another rendering of a related live broadcast content item according to a currently received broadcast of the related live broadcast content item, wherein the previously broadcast content item and the related live broadcast content item are related at least by being from a same source of broadcast content;
receiving input by the device to select the rendering of the previously broadcast content item; and
terminating the other rendering of the related live broadcast content item in response to the receiving the input by the device.

16. The non-transitory computer readable medium of claim 15, wherein the operations further comprise:
receiving user identification data that identifies a user identity associated with the device.

17. The non-transitory computer readable medium of claim 16, wherein the initiating the rendering of the previously broadcast content item and the initiating the other rendering of the related live broadcast content item are performed as a function of the user identification data.

18. The non-transitory computer readable medium of claim 16, wherein the operations further comprise:
tagging the previously broadcast content item resulting in a tag being applied to the previously broadcast content item, and
wherein the tagging is associated with the user identity.

19. The non-transitory computer readable medium of claim 18, wherein the tagging of the previously broadcast content item comprises tagging the previously broadcast content item with keyword data.

20. The non-transitory computer readable medium of claim 18, wherein the tagging of the previously broadcast content item comprises tagging the previously broadcast content item with metadata.

21. A method comprising:
storing, by a network device comprising a processor, previously broadcasted video content data associated with a channel;
partitioning, by the network device, the previously broadcasted video content data associated with the channel resulting in partitioned previously broadcasted video content data;
tagging, by the network device, the partitioned previously broadcasted video content data;
grouping, by the network device, the partitioned previously broadcasted video content data based on a tag applied to the partitioned previously broadcasted video content data;
displaying, by the network device, a group of previously broadcasted video content data based on an association of the tag applied to the partitioned previously broadcasted video content data; and
displaying, by the network device, currently broadcasted video content data, wherein the group of previously broadcasted video content data and the currently broadcasted video content data are displayed concurrently.

22. The method of claim 21, further comprising:
preventing, by the network device, a genre of broadcasted video content data from being displayed based on a user preference associated with the previously broadcast video content data.

23. The method of claim 21, further comprising:
displaying, by the network device, notification data, set by a user, associated with a start time of future broadcast video content data.

24. The method of claim 21, wherein the displaying the group of previously broadcasted video content data comprises displaying a representation of the group of previously broadcasted video content data of the channel and the currently broadcasted video content data of the channel.

25. The method of claim 21, wherein the partitioning is based on metadata associated with the previously broadcasted video content data.

26. The method of claim 21, further comprising:
deleting, by the network device, the currently broadcasted video content data based on a user identity and preference data representing a preference of a time of broadcast, a genre, a show title, a location of origin, or a character.

27. The method of claim 21, further comprising:
deleting, by the network device, the currently broadcasted video content data after a broadcast is complete to prevent the currently broadcasted video content data from becoming the previously broadcasted video content data.
